(19) United States
(12) Patent Application Publication
(10) Pub. No.: US 2023/0334237 A1
(43) Pub. Date: Oct. 19, 2023

(54) WORKBOOK TEMPLATE SHARING

(71) Applicant: SIGMA COMPUTING, INC., SAN FRANCISCO, CA (US)

(72) Inventors: JASON D. FRANTZ, SAN FRANCISCO, CA (US); ROBERT C. WOOLLEN, SAN RAFAEL, CA (US); IAN GARDNER, SAN FRANCISCO, CA (US); SIYUAN FAN, SAN FRANCISCO, CA (US); ERICA K. CHASE, MARTINEZ, CA (US)

(21) Appl. No.: 17/720,721

(22) Filed: Apr. 14, 2022

(51) Int. Cl. G06F 40/186; G06F 16/21; G06F 40/18

(52) U.S. Cl. CPC G06F 40/186; G06F 16/212; G06F 40/18

(57) ABSTRACT

Workbook template sharing including receiving, by a table manager, a request to create a workbook from a workbook template using data in a cloud-based data warehouse, wherein the workbook template comprises a fingerprint describing an input schema hierarchy; determining, by the table manager, data pathways for the workbook by matching the fingerprint of the workbook template to a schema hierarchy of the data in the cloud-based data warehouse; and generating, by the table manager, the workbook according to the workbook template using the data pathways.

### BACKGROUND

### Field of the Invention

The field of the invention is data processing, or, more specifically, methods, apparatus, and products for workbook template sharing.

### Description Of Related Art

Modern businesses may store large amounts of data in remote databases within cloud-based data warehouses. This data may be accessed using database statement languages, such as structured query language (SQL). Manipulating the data stored in the database may require constructing complex queries beyond the abilities of most users. Further, composing and issuing database queries efficiently may also be beyond the abilities of most users.

### SUMMARY

Methods, systems, and apparatus for workbook template sharing including receiving, by a table manager, a request to create a workbook from a workbook template using data in a cloud-based data warehouse, wherein the workbook template comprises a fingerprint describing an input schema hierarchy; determining, by the table manager, data pathways for the workbook by matching the fingerprint of the workbook template to a schema hierarchy of the data in the cloud-based data warehouse; and generating, by the table manager, the workbook according to the workbook template using the data pathways.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for workbook template sharing according to embodiments of the present invention.

FIG. 2 sets forth a block diagram of an example system configured for workbook template sharing according to embodiments of the present invention.

FIG. 3 sets forth a block diagram of an example system configured for workbook template sharing according to embodiments of the present invention.

FIG. 4 sets forth a flow chart illustrating an exemplary method for workbook template sharing according to embodiments of the present invention.

FIG. 5 sets forth a flow chart illustrating an exemplary method for workbook template sharing according to embodiments of the present invention.

FIG. 6 sets forth a flow chart illustrating an exemplary method for workbook template sharing according to embodiments of the present invention.

### DETAILED DESCRIPTION

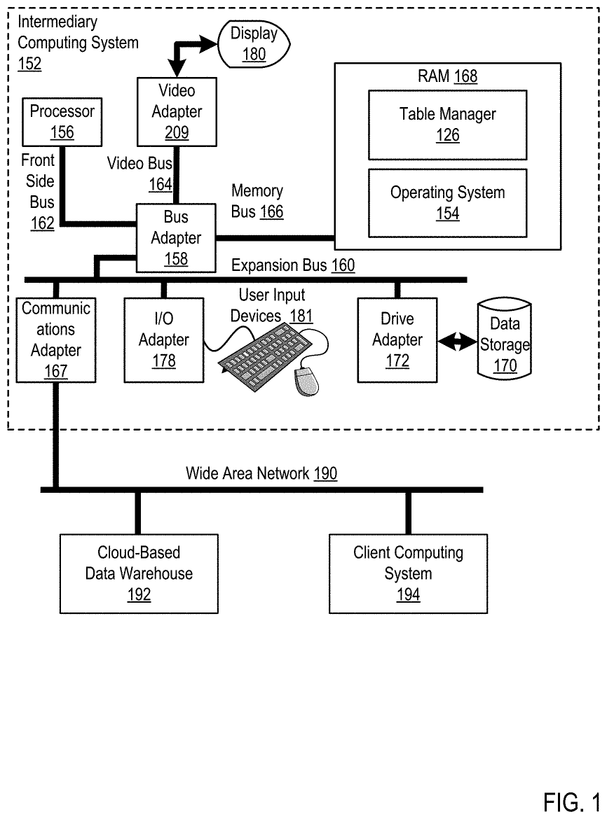

Exemplary methods, apparatus, and products for workbook template sharing in accordance with the present invention are described with reference to the accompanying drawings, beginning with FIG. 1. FIG. 1 sets forth a block diagram of automated computing machinery comprising an exemplary intermediary computing system 152 configured for workbook template sharing according to embodiments of the present invention. The intermediary computing system 152 of FIG. 1 includes at least one computer processor 156 or ‘CPU’ as well as random access memory 168 (‘RAM’) which is connected through a high speed memory bus 166 and bus adapter 158 to processor 156 and to other components of the intermediary computing system 152.

Stored in RAM 168 is an operating system 154. Operating systems useful in computers configured for workbook template sharing according to embodiments of the present invention include UNIX™, Linux™, Microsoft Windows™, AIX™, and others as will occur to those of skill in the art. The operating system 154 in the example of FIG. 1 is shown in RAM 168, but many components of such software typically are stored in non-volatile memory also, such as, for example, on data storage 170, such as a disk drive. Also stored in RAM is the table manager 126, a module for workbook template sharing according to embodiments of the present invention.

The intermediary computing system 152 of FIG. 1 includes disk drive adapter 172 coupled through expansion bus 160 and bus adapter 158 to processor 156 and other components of the intermediary computing system 152. Disk drive adapter 172 connects non-volatile data storage to the intermediary computing system 152 in the form of data storage 170. Disk drive adapters useful in computers configured for workbook template sharing according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example intermediary computing system 152 of FIG. 1 includes one or more input/output (‘I/O’) adapters 178. I/O adapters implement user-oriented input/output through, for example, software drivers and computer hardware for controlling output to display devices such as computer display screens, as well as user input from user input devices 181 such as keyboards and mice. The example intermediary computing system 152 of FIG. 1 includes a video adapter 209, which is an example of an I/O adapter specially designed for graphic output to a display device 180 such as a display screen or computer monitor. Video adapter 209 is connected to processor 156 through a high speed video bus 164, bus adapter 158, and the front side bus 162, which is also a high speed bus.

The exemplary intermediary computing system 152 of FIG. 1 includes a communications adapter 167 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for workbook template sharing according to embodiments of the present invention include modems for wired dial-up communications, Ethernet (IEEE 802.3) adapters for wired data communications, and 802.11 adapters for wireless data communications.

The communications adapter 167 is communicatively coupled to a wide area network 190 that also includes a cloud-based data warehouse 192 and a client computing system 194. The cloud-based data warehouse 192 is a computing system or group of computing systems that hosts a database or databases for access over the wide area network 190. The client computing system 194 is a computing system that accesses the database using the table manager 126.

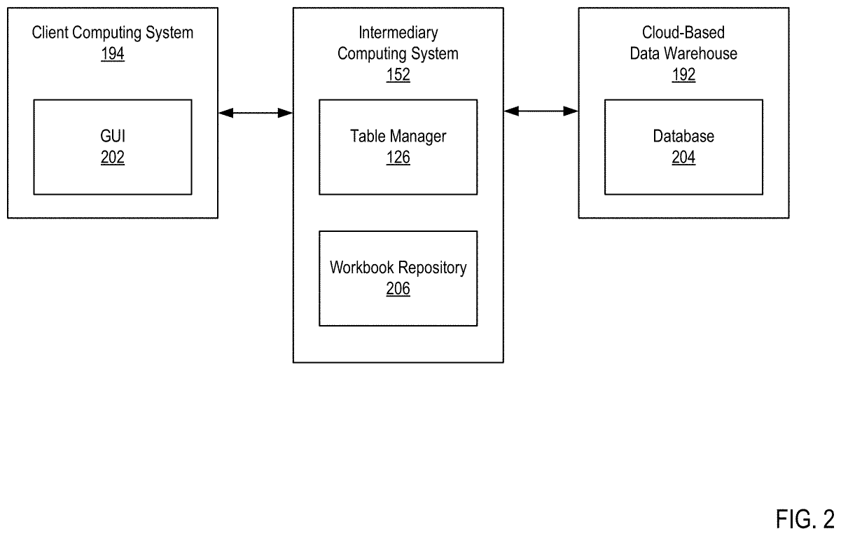

FIG. 2 shows an exemplary system for workbook template sharing according to embodiments of the present invention. As shown in FIG. 2, the system includes a client computing system 194, an intermediary computing system 152, and a cloud-based data warehouse 192. The client computing system 194 includes a graphical user interface (GUI) 202. The intermediary computing system 152 includes a table manager 126 and a workbook repository 206. The cloud-based data warehouse 192 includes a database 204. The client computing system 194 may access the cloud-based data warehouse 192 and database 204 via the table manager on the intermediary computing system 152.

The GUI 202 is a visual presentation configured to present data sets in the form of workbooks to a user. The GUI 202 also receives requests from a user for data sets from the database 204. The GUI 202 may also present to the user the ability to add a new row into a data set or table and enter values for each column of the new row. The GUI 202 may be presented, in part, by the table manager 126 and displayed on a client computing system 194 (e.g., on a system display or mobile touchscreen). The GUI 202 may be part of an Internet application that includes the table manager 126 and is hosted on the intermediary computing system 152.

The database 204 is a collection of data and a management system for the data. A data set is a collection of data (such as a table) from the database 204. Data sets may be organized into columns and rows (also referred to as records). The particular columns, rows, and organization of the columns and rows that make up a data set may be specified in the database statement requesting the data set. Data sets may be sent from the cloud-based data warehouse 192 in response to a database statement (also referred to as a query). Accordingly, data sets retrieved in response to a database statement may be referred to as query results.

The table manager 126 is hardware, software, or an aggregation of hardware and software configured to receive instructions in the form of state specifications from the client computing system 194, via the GUI 202. The table manager 126 is also configured to present workbooks in the GUI 202 response to the instructions, which may include generating database statements in response to manipulations of the GUI 202 described in the state specification.

The state specification is a collection of data describing inputs into the GUI 202. The state specification may include manipulations of GUI elements within the GUI 202 along with data entered into the GUI 202 by a user of the client computing system 194. Such manipulations and data may indicate requests for and manipulations of data sets. Such manipulations and data may also indicate requests to edit an existing row or create a new row and values for that row. The state specification may be a standard file format used to exchange data in asynchronous browser-server communication. For example, the state specification may be a JavaScript Object Notation specification. The state specification may also include descriptions of elements that are used to apply changes to the data set. Such elements may include filters applied to the workbook, the hierarchical level of the workbook, joins performed within the workbook, exposable parameters in the workbook, and security for the workbook.

The table manager 126 may use the state specification as input to generate a database statement. This database statement generation process may begin with state specification being converted into an abstract syntax tree. The abstract syntax tree may then be canonicalized into a canonicalized hierarchy. The canonicalized hierarchy may then be linearized into the workbook algebra. The workbook algebra may then be lowered into a relational algebra, which may then be lowered into the database statement.

The table manager 126 may use the database statement to fetch query results (i.e., a data set) from the database 204. The table manager 126 may then present the query results to a user via the GUI 202. The table manager 126 may further manage tables on the database 202 to which a user has made edits, such as adding new rows or editing existing rows. Further, the table manager 126 may add columns to new rows and create new tables on the database 202.

The table manager 126 may service requests in the state specification using workbooks local to the table manager 126. A workbook is a presentation of a data set in the GUI 202. Specifically, a workbook is metadata describing a particular organization and configuration of a data set for presentation via the GUI 202. A workbook may include multiple elements including a visualization and a spreadsheet structure. For example, a workbook may include a spreadsheet structure presenting data points from a data set and an accompanying visualization may present a graph of the data points. Such workbooks may be stored in the workbook repository 206.

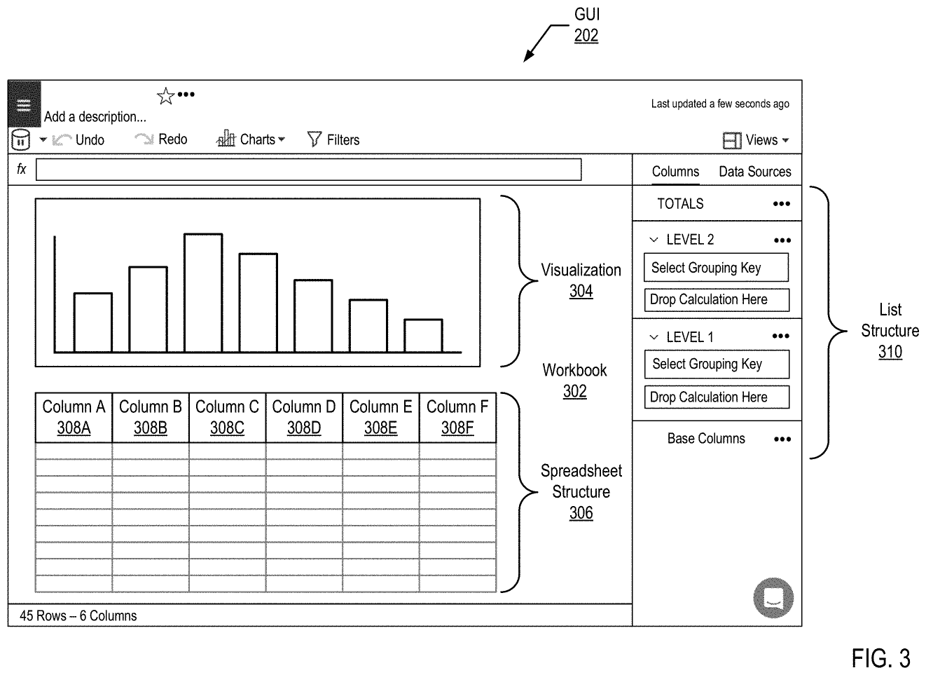

FIG. 3 shows an exemplary system for workbook template sharing according to embodiments of the present invention. As shown in FIG. 3, the exemplary GUI 202 includes a workbook 302 and a list structure 310. The workbook 302 includes a visualization 304 and a spreadsheet structure 306 (shown as empty rows) with six columns (column A 308A, column B 308B, column C 308C, column D 308D, column E 308E, column F 308F).

The workbook 302 is a collection of graphical elements and organizing mechanism for a data set. The workbook may present a data set retrieved by the table manager from a cloud-based data warehouse. Specifically, the table manager may generate a database statement in response to the request from a client. The database statement may then be issued to the cloud-based data warehouse and the data set may be received as the query results of the database statement. The data set may then be organized based on the workbook retrieved from the workbook repository. The table manager itself may reside on an intermediary computing system between the client computing system and the cloud-based data warehouse.

As shown in FIG. 3, the workbook 302 includes a visualization 304 and a spreadsheet structure 306. The visualization 304 is a graphical element that conveys relationships between data in the data set. The visualization 304 may include, for example, graphs, charts, and/or maps. The spreadsheet structure 306 is a presentation of a data set (such as a table) from a database on a data warehouse. The spreadsheet structure 306 displays rows of data organized by columns (column A 308A, column B 308B, column C 308C, column D 308D, column E 308E, column F 308F). The columns delineate different categories of the data in each row. The columns may also be calculation columns that include calculation results using other columns in the spreadsheet structure 306. Both the visualization 304 and the spreadsheet structure 306 may include dynamic elements and be configured to interact with a client via the GUI 202.

The list structure 310 is a graphical element used to define and organize the hierarchical relationships between the columns (column A 308A, column B 308B, column C 308C, column D 308D, column E 308E, column F 308F) of the data set. The term “hierarchical relationship” refers to subordinate and superior groupings of columns. For example, a database may include rows for an address book, and columns for state, county, city, and street. A data set from the database may be grouped first by state, then by county, and then by city. Accordingly, the state column would be at the highest level in the hierarchical relationship, the county column would be in the second level in the hierarchical relationship, and the city column would be at the lowest level in the hierarchical relationship.

The list structure 310 presents a dimensional hierarchy to the user. Specifically, the list structure 310 presents levels arranged hierarchically across at least one dimension. Each level within the list structure 310 is a position within a hierarchical relationship between columns (column A 308A, column B 308B, column C 308C, column D 308D, column E 308E, column F 308F). The keys within the list structure 310 identify the one or more columns that are the participants in the hierarchical relationship. Each level may have more than one key.

One of the levels in the list structure 310 may be a base level. Columns selected for the base level provide data at the finest granularity. One of the levels in the list structure 310 may be a totals or root level. Columns selected for the totals level provide data at the highest granular level. For example, the totals level may include a field that calculates the sum of each row within a single column of the entire data set (i.e., not partitioned by any other column).

The GUI 202 may enable a user to drag and drop columns (column A 308A, column B 308B, column C 308C, column D 308D, column E 308E, column F 308F) into the list structure 310. The order of the list structure 310 may specify the hierarchy of the columns relative to one another. A user may be able to drag and drop the columns in the list structure 310 at any time to redefine the hierarchical relationship between columns. The hierarchical relationship defined using the columns selected as keys in the list structure 310 may be utilized in charts such that drilling down (e.g., double click on a bar), enables a new chart to be generated based on a level lower in the hierarchy.

The GUI 202 may also include a mechanism for a user to request a table from a database to be presented as a workbook in the GUI 202. Such a mechanism may be part of the interactivity of the workbook. Specifically, a user may manipulate a workbook (e.g., by dragging and dropping columns or rows, resorting columns or rows, manipulating a graph etc.) and, in response, the GUI 202 may generate a request (e.g., in the form of a state specification) for a data set and send the request to the table manager 126. Such a mechanism may also include a direct identification of the rows and columns of a database table that a user would like to access (e.g., via a selection of the rows and columns in a dialog box). The GUI 202 may also include a mechanism for a user to create a new table on the database, add rows to a table, and move rows within the table.

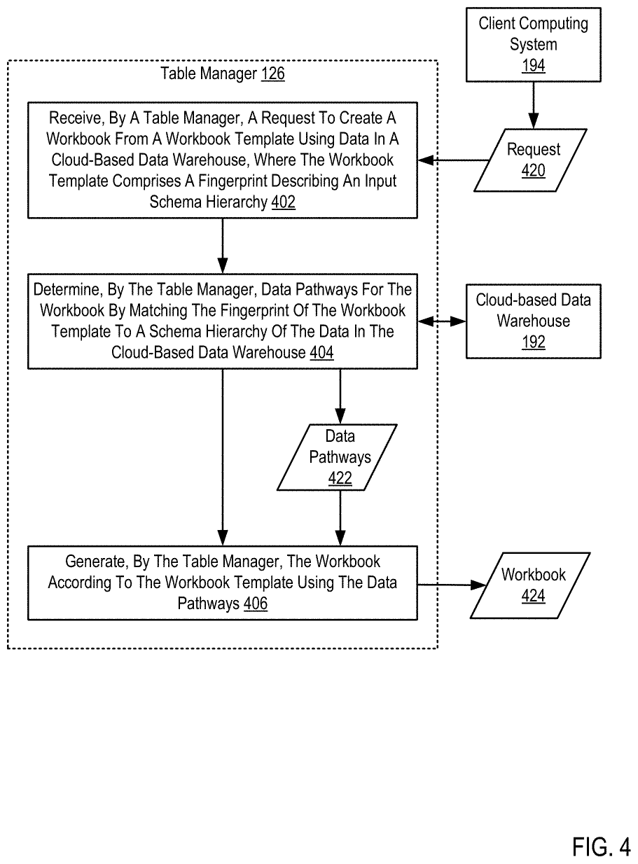

For further explanation, FIG. 4 sets forth a flow chart illustrating an exemplary method for workbook template sharing according to embodiments of the present invention that includes receiving 402, by a table manager 126, a request 420 to create a workbook 424 from a workbook template using data in a cloud-based data warehouse 192, wherein the workbook template comprises a fingerprint describing an input schema hierarchy. Receiving 402 the request 420 to create the workbook 424 from a workbook template may be carried out by detecting that the client on the client computing system 194 has manipulated elements of the GUI and/or submitted data using the GUI such that the generation of the request 420 is triggered, and the request 420 is sent to the table manager 126. The request 420 may be received in the form of a state specification from the GUI. Specifically, each change to the GUI may result in a new or updated state specification 420 that operates as an instruction to the table manager 126.

As discussed above, a workbook is a collection of graphical elements and organizing mechanism for a particular (known) data set. A workbook template is a collection of graphical elements and organizing mechanism for a type of data set. The workbook template may be used to create a workbook for any data set from data on a cloud-based data warehouse that conforms to a particular structure (i.e., schema hierarchy). For example, a workbook template may be created for store inventory, and may be used by any organization that structures their inventory data in a way that approximately conforms to the schema hierarchy used by the workbook template.

The workbook template includes a fingerprint describing an input schema hierarchy. Specifically, the fingerprint refers to a description of the expected schema hierarchy for data used by that particular workbook template. The schema hierarchy refers to the structure of data on a cloud-based data warehouse. The schema hierarchy may include databases, folders, tables, and columns and relationships between elements. The fingerprint describes the expected inputs for a workbook created using the workbook template. The fingerprint may describe elements in the schema hierarchy such that exact name matches are not required to determine data pathways between the elements of the input schema hierarchy and the database schema and folders of the data in the cloud-based data warehouse (and thus use the data to create a workbook using the workbook template).

Receiving 402 the request 420 to create the workbook 424 from a workbook template may also be carried out by receiving a selection, by a client, of the workbook template from a repository of workbook templates presented to the client. For example, a client may access a workbook template repository, such as a template store, and select one of the presented workbook templates. The workbook templates may be organized by data type, industry, creator, etc.

The workbook template may be created by receiving an original workbook and converting the schema hierarchy in the original workbook into the fingerprint describing the input schema hierarchy. Converting the schema hierarchy into the fingerprint may include determine broadened descriptions for each data path used by the original workbook. The broadened descriptions may then be collected as the input schema hierarchy for the workbook template.

The method of FIG. 4 also includes determining 40, by the table manager 126, data pathways 422 for the workbook 424 by matching the fingerprint of the workbook template to a schema hierarchy of the data in the cloud-based data warehouse 192. The data pathways 422 are the elements and locations of the elements within the data through which the workbook template accesses the data set to create the workbook. The data pathways 422 may include database schema and folder information about the data in the cloud-based data warehouse 192.

Matching the fingerprint of the workbook template to the schema hierarchy of the data in the cloud-based data warehouse 192 may include, for each element in the input schema hierarchy, determining an existence and location for the corresponding element in the data database schema and folders on the cloud-based data warehouse 192. The existence and location for the corresponding elements may be determined using a variety of methods. For example, the similarity between the names (e.g., a table name) of elements in the input schema hierarchy and data on the cloud-based data warehouse may indicate a match or potential match. As another example, the location of one element relative to another element within the data on the cloud-based data warehouse may indicate a match with an element with a similar relative location in the input schema hierarchy. A cumulation of match indicators may be used to make a final determination regarding whether two elements match and therefore may be used to create a data pathway.

The method of FIG. 4 also includes generating 406, by the table manager 126, the workbook 424 according to the workbook template using the data pathways 422. Generating 406 the workbook 424 according to the workbook template may be carried out by storing the workbook in a workbook repository with a schema hierarchy based on the data pathways 422. Once the data pathways 422 have been determined, those data pathways 422 may be stored with the schema hierarchy of the workbook for later use in generating a database statement to retrieve the dataset from the cloud-based data warehouse 192.

The above limitations improve the operation of the computer system by enabling a client to offload workbook creation to a workbook template creator. The above limitations further improve the operation of the computer system by providing workbook templates to clients who lack the ability to create complex analysis tools on their own. This is performed by using templates to create workbooks by determining a set of data pathways that allow the template to retrieve the appropriate categories of data for presentation in the workbook by the table manager.

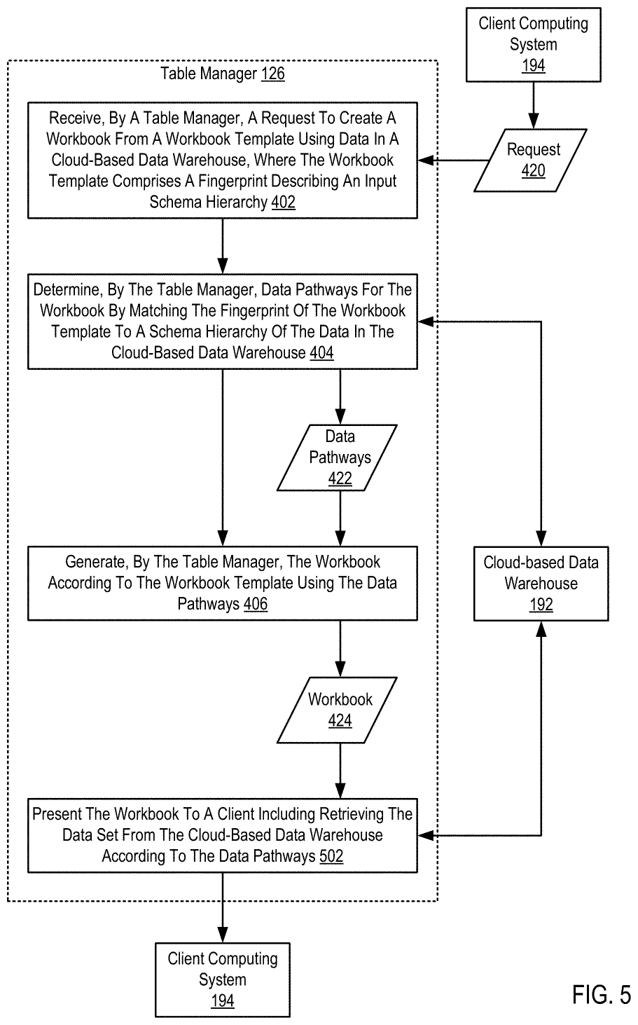

For further explanation, FIG. 5 sets forth a flow chart illustrating a further exemplary method for workbook template sharing according to embodiments of the present invention that includes receiving 402, by a table manager 126, a request 420 to create a workbook 424 from a workbook template using data in a cloud-based data warehouse 192, wherein the workbook template comprises a fingerprint describing an input schema hierarchy; determining 404, by the table manager 126, data pathways 422 for the workbook 424 by matching the fingerprint of the workbook template to a schema hierarchy of the data in the cloud-based data warehouse 192; and generating 406, by the table manager 126, the workbook 424 according to the workbook template using the data pathways 422.

The method of FIG. 5 differs from the method of FIG. 4, however, in that FIG. 5 further includes presenting 502 the workbook 424 to a client on a client computing system 194 including retrieving the data set from the cloud-based data warehouse 192 according to the data pathways 422. Retrieving the data set from the cloud-based data warehouse 192 according to the data pathways 422 may be carried out by generating a database statement targeting a data set from the data described by the data pathways on the cloud-based data warehouse. Subsequently, the table manager 126 may issue, to the cloud-based data warehouse 192, the database statement targeting data described by the data pathways. In response, the table manager 126 may receive, as query results, the data set. Presenting 502 the workbook 424 to a client may further be carried out by structuring the received data set and visualizations for in the GUI of the client computing system 194.

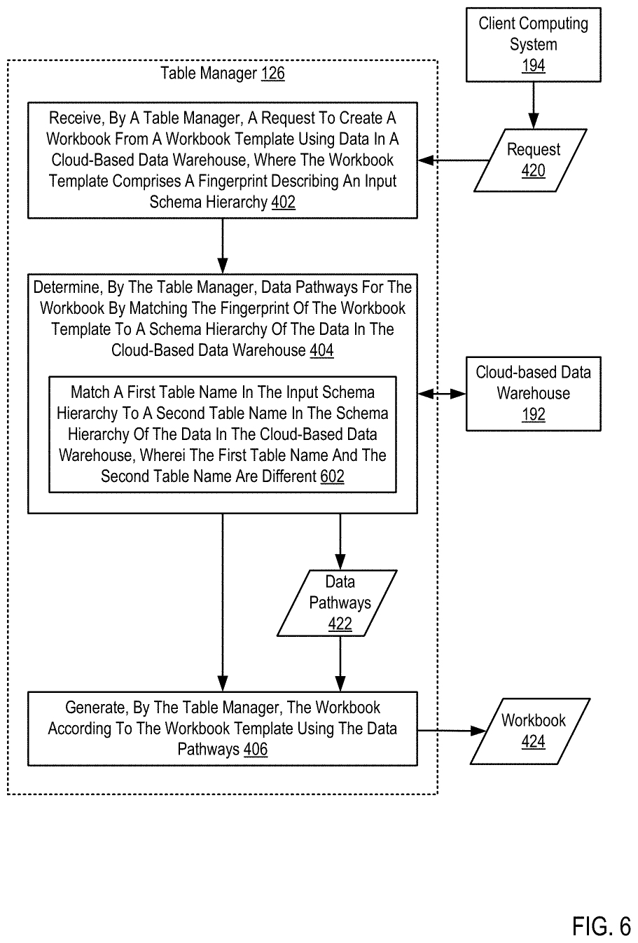

For further explanation, FIG. 6 sets forth a flow chart illustrating a further exemplary method for workbook template sharing according to embodiments of the present invention that includes receiving 402, by a table manager 126, a request 420 to create a workbook 424 from a workbook template using data in a cloud-based data warehouse 192, wherein the workbook template comprises a fingerprint describing an input schema hierarchy; determining 404, by the table manager 126, data pathways 422 for the workbook 424 by matching the fingerprint of the workbook template to a schema hierarchy of the data in the cloud-based data warehouse 192; and generating 406, by the table manager 126, the workbook 424 according to the workbook template using the data pathways 422.

The method of FIG. 6 differs from the method of FIG. 4, however, in that determining 404, by the table manager 126, data pathways 422 for the workbook 424 includes matching 602 a first table name in the input schema hierarchy to a second table name in the schema hierarchy of the data in the cloud-based data warehouse 192, wherein the first table name and the second table name are different. The workbook may include a number of synonyms and alternate terms for each table (or other element) in the input schema hierarchy. When matching a table (or other element) the table manager 126 may attempt to match any of the group of synonyms and alternate terms for each element to a corresponding element in the data on the cloud-based data warehouse 192. Matching 602 the first table name in the input schema hierarchy to the second table name in the schema hierarchy of the data in the cloud-based data warehouse 192 may be carried out by iterating through each synonym and alternate term for an element to determine where that element exists within the data on the cloud-based data warehouse. For example, a table “sales” in the input schema hierarchy may be matched to a table name “product orders” in the schema hierarchy of the data in the cloud-based data warehouse 192.

The first table name may be matched to the second table name based on column names in the second table identified by the second table name. Specifically, in addition to the process described above, the table manager may also attempt to match a table in the input schema hierarchy to a table on the cloud-based data warehouse based on the names of columns within that table. A match for a table may be found if the tables include the same or similar column names. For example, a table “sales” in the input schema hierarchy with columns “date”, “item” and “quantity” may be matched to a table name “orders” with columns “date”, “item” and “quantity” in the schema hierarchy of the data in the cloud-based data warehouse 192. These processes may be used in conjunction with one another, as well as other not specifically described.

In view of the explanations set forth above, readers will recognize that the benefits of workbook template sharing according to embodiments of the present invention include:
Improving the operation of the computer system by enabling a client to offload workbook creation to a workbook template creator, increasing system functionality.
Improving the operation of the computer system by providing workbook templates to clients who lack the ability to create complex analysis tools on their own, increasing system robustness.

Exemplary embodiments of the present invention are described largely in the context of a fully functional computer system for workbook template sharing. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for workbook template sharing, the method comprising:
receiving, by a table manager, a request to create a workbook from a workbook template using data in a cloud-based data warehouse, wherein the workbook template comprises a fingerprint describing an input schema hierarchy;
determining, by the table manager, data pathways for the workbook by matching the fingerprint of the workbook template to a schema hierarchy of the data in the cloud-based data warehouse; and
generating, by the table manager, the workbook according to the workbook template using the data pathways.

2. The method of claim 1, further comprising:
presenting the workbook to a client including retrieving the data set from the cloud-based data warehouse according to the data pathways, wherein the schema hierarchy refers to a structure of the data in the cloud-based data warehouse, and wherein the fingerprint describes an expected input schema hierarchy for a workbook generated according to the workbook template.

3. The method of claim 2, wherein retrieving the data set from the cloud-based data warehouse according to the data pathways comprises issuing, to the cloud-based data warehouse, a database statement targeting data described by the data pathways, wherein the schema hierarchy includes relationships between one or more of:
databases, folders, tables, and columns.

4. The method of claim 1, wherein matching the fingerprint of the workbook template to the schema hierarchy of the data in the cloud-based data warehouse comprises matching a first table name in the input schema hierarchy to a second table name in the schema hierarchy of the data in the cloud-based data warehouse, wherein the first table name and the second table name are different.

5. The method of claim 4, wherein the first table name is matched to the second table name based on column names in a second table identified by the second table name.

6. The method of claim 1, wherein the data pathways comprise database schema and folder information about the data in the cloud-based data warehouse.

7. The method of claim 1, wherein receiving the request to create the workbook from the workbook template using the data in the cloud-based data warehouse the workbook comprises receiving a selection, by a client, of the workbook template from a repository of workbook templates presented to the client.

8. The method of claim 1, wherein the workbook template is created by receiving an original workbook and converting the schema hierarchy in the original workbook into the fingerprint describing the input schema hierarchy.

9. The method of claim 1, wherein generating the workbook according to the workbook template using the data pathways comprises storing the workbook in a workbook repository with a schema hierarchy based on the data pathways.

10. The method of claim 1, wherein the table manager is executing on an intermediary computing system between a client computing system sending the request and the cloud-based data warehouse.

11. An apparatus for workbook template sharing, the apparatus comprising a computer processor, a computer memory operatively coupled to the computer processor, the computer memory having disposed within it computer program instructions that, when executed by the computer processor, cause the apparatus to carry out the steps of:
receiving, by a table manager, a request to create a workbook from a workbook template using data in a cloud-based data warehouse, wherein the workbook template comprises a fingerprint describing an input schema hierarchy;
determining, by the table manager, data pathways for the workbook by matching the fingerprint of the workbook template to a schema hierarchy of the data in the cloud-based data warehouse; and
generating, by the table manager, the workbook according to the workbook template using the data pathways.

12. The apparatus of claim 11, wherein the computer program instructions further cause the apparatus to carry out the steps of:
presenting the workbook to a client including retrieving the data set from the cloud-based data warehouse according to the data pathways.

13. The apparatus of claim 12, wherein retrieving the data set from the cloud-based data warehouse according to the data pathways comprises issuing, to the cloud-based data warehouse, a database statement targeting data described by the data pathways.

14. The apparatus of claim 11, wherein matching the fingerprint of the workbook template to the schema hierarchy of the data in the cloud-based data warehouse comprises matching a first table name in the input schema hierarchy to a second table name in the schema hierarchy of the data in the cloud-based data warehouse, wherein the first table name and the second table name are different.

15. The apparatus of claim 14, wherein the first table name is matched to the second table name based on column names in a second table identified by the second table name.

16. The apparatus of claim 11, wherein the data pathways comprise database schema and folder information about the data in the cloud-based data warehouse.

17. The apparatus of claim 11, wherein receiving the request to create the workbook from the workbook template using the data in the cloud-based data warehouse the workbook comprises receiving a selection, by a client, of the workbook template from a repository of workbook templates presented to the client.

18. The apparatus of claim 11, wherein the workbook template is created by receiving an original workbook and converting the schema hierarchy in the original workbook into the fingerprint describing the input schema hierarchy.

19. The apparatus of claim 11, wherein generating the workbook according to the workbook template using the data pathways comprises storing the workbook in a workbook repository with a schema hierarchy based on the data pathways.

20. A computer program product for workbook template sharing, the computer program product disposed upon a computer readable medium, the computer program product comprising computer program instructions that, when executed, cause a computer to carry out the steps of:
receiving, by a table manager, a request to create a workbook from a workbook template using data in a cloud-based data warehouse, wherein the workbook template comprises a fingerprint describing an input schema hierarchy;
determining, by the table manager, data pathways for the workbook by matching the fingerprint of the workbook template to a schema hierarchy of the data in the cloud-based data warehouse; and
generating, by the table manager, the workbook according to the workbook template using the data pathways.
